(19) United States
(12) Patent Application Publication
(10) Pub. No.: US 2010/0130166 A1
(43) Pub. Date: May 27, 2010

(54) SLIM AUTHENTICATION TAG

(76) Inventors: YOSSEF TSURIA, Jerusalem (IL); Benjamin May-Tal, Mevasseret Zion (IL)

Correspondence Address: DANIEL J SWIRSKY, 55 REUVEN ST., BEIT SHEMESH, 99544, IL

(21) Appl. No.: 12/276,620

(22) Filed: Nov. 24, 2008

(51) Int. Cl. H04M 1/66

(52) U.S. Cl. 455/411

(57) ABSTRACT

Authenticating a communication device utilizing a slim tag comprising fewer elements than an ordinary authentication tag. The slim authentication tag utilizes at least one of the components of its host communication device in order to establish a communication session with a second communication device. The second communication device may communicate with an authentication server for authenticating the host communication device.

### BACKGROUND OF THE INVENTION

FIG. 1 illustrates the main elements of a prior art authentication tag 100 enabling a wireless authentication such as the challenge-response authentication process disclosed in PCT/IL2007/001459, incorporated herein by reference. The tag 100 comprises: a memory 102 for the authentication software, such as random access memory (RAM); an authentication block 104, such as a challenge-response authentication block or any other symmetric or asymmetric authentication logic; a memory 106 for storing the authentication identification number, such as EEPROM; a microcontroller 108; a short range communication device 110, such as Bluetooth communication; and a power supply 112.

Optionally, the authentication tag 100 is coupled to an electronic device 120. The electronic device 120 comprises a memory 122, a microcontroller 124, a short range communication element 126 such as Bluetooth, and a power supply 128.

Basic principles and details relating to communication and product authentication needed for properly understanding the embodiments of the present invention are provided herein. Complete theoretical descriptions, details, explanations, examples, and applications of these, related subjects, and phenomena are readily available in standard references in the fields of communication, encryption, and authentication.

### SUMMARY OF THE INVENTION

Some of the embodiments of the invention make it possible to authenticate a communication device, but without coupling a complete tag to the communication device. Moreover, some of the embodiments make it possible to authenticate a communication device with a slim tag comprising fewer elements than an ordinary tag. Examples of communication devices include, but are not limited to, a phone, a Personal Digital Assistant (PDA), and a computer.

In one embodiment, a host communication device comprising: a slim tag for authenticating the host communication device by utilizing short range communication; wherein the slim tag utilizes at least one of the components of the host communication device in order to establish a short range communication session with a second communication device.

In one embodiment, a slim authentication tag to be integrated in a host communication device; the slim authentication tag comprises an authentication block and utilizes at least one of the components of its host communication device in order to establish a communication session with a second communication device; wherein the second communication device authenticates the host communication device by communicating with an authentication server.

In one embodiment, a slim authentication tag to be integrated in a host communication device; the slim authentication tag comprises a microcontroller and utilizes at least one of the components of its host communication device in order to establish a communication session with a second communication device; wherein the second communication device authenticates the host communication device by communicating with an authentication server.

Implementations of the disclosed embodiments involve performing or completing selected tasks or steps manually, semi-automatically, fully automatically, and/or a combination thereof. Moreover, depending upon actual instrumentation and/or equipment used for implementing the disclosed embodiments, several embodiments could be achieved by hardware, by software, by firmware, or a combination thereof. In particular, with hardware, embodiments of the invention could exist by variations in the physical structure. Additionally, or alternatively, with software, selected functions of the invention could be performed by a data processor, such as a computing platform, executing software instructions or protocols using any suitable computer operating system.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1 is a schematic diagram illustrating a prior art authentication tag;

FIG. 2 is a schematic diagram illustrating one embodiment of an authentication tag implemented entirely by the host communication device;

FIG. 3 is a schematic diagram illustrating one embodiment of a slim tag coupled to a host communication device;

FIG. 4 is a schematic diagram illustrating one embodiment of a slim tag coupled to a host device;

FIG. 5 is a schematic diagram illustrating one embodiment of a slim tag coupled to a host communication device;

FIG. 6 is a schematic diagram illustrating one embodiment of a slim tag coupled to a host communication device;

FIG. 7 is a schematic diagram illustrating one embodiment of a slim tag coupled to a host communication device;

FIG. 8 is a schematic diagram illustrating one embodiment of a slim tag coupled to a host communication device;

FIG. 9 is a schematic diagram illustrating one embodiment of a slim tag coupled to a host communication device; and

FIG. 10 is a flow diagram of one embodiment of the invention.

### DETAILED DESCRIPTION OF THE INVENTION

In the following description, numerous specific details are set forth. However, the embodiments of the invention may be practiced without some of these specific details. In other instances, well-known hardware, software, materials, structures and techniques have not been shown in detail in order not to obscure the understanding of this description. In this description, references to “one embodiment” or “an embodiment” mean that the feature being referred to may be included in at least one embodiment of the invention. Moreover, separate references to “one embodiment” in this description do not necessarily refer to the same embodiment. Illustrated embodiments are not mutually exclusive, unless so stated and except as will be readily apparent to those of ordinary skill in the art. Thus, the invention may include any variety of combinations and/or integrations of the embodiments described herein. Also herein, flow diagrams illustrate non-limiting embodiment examples of the methods, and block diagrams illustrate non-limiting embodiment examples of the devices. Some operations in the flow diagrams may be described with reference to the embodiments illustrated by the block diagrams. However, the methods of the flow diagrams could be performed by embodiments of the invention other than those discussed with reference to the block diagrams, and embodiments discussed with reference to the block diagrams could perform operations different from those discussed with reference to the flow diagrams. Moreover, although the flow diagrams may depict serial operations, certain embodiments could perform certain operations in parallel and/or in different orders from those depicted. Moreover, the use of repeated reference numerals and/or letters in the text and/or drawings is for the purpose of simplicity and clarity and does not in itself dictate a relationship between the various embodiments and/or configurations discussed. Furthermore, methods and mechanisms of the embodiments will sometimes be described in singular form for clarity. However, it should be noted that some embodiments may include multiple iterations of a method or multiple instantiations of a mechanism unless noted otherwise. For example, when a controller or an interface are disclosed in an embodiment, the scope of the embodiment is intended to also cover the use of multiple controllers or interfaces.

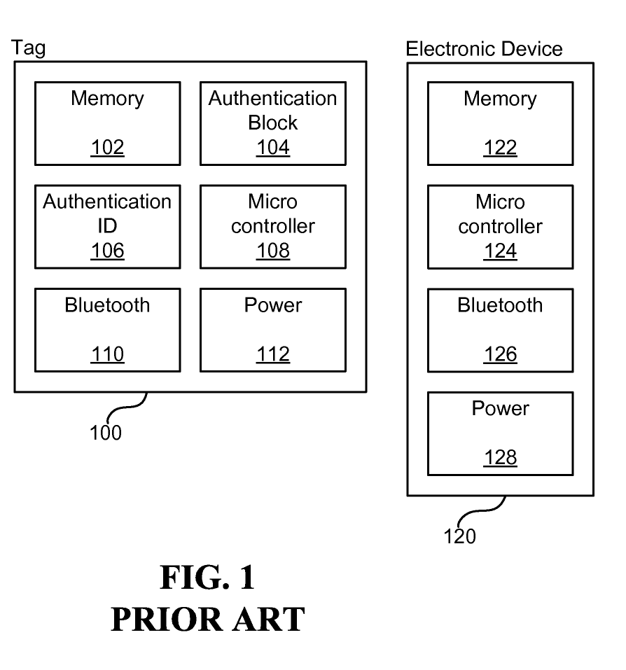

Some of the embodiments disclose slim authentication tags comprising fewer elements than some known authentication tags, such as the tag illustrated in FIG. 1. The slim tag is coupled to a host communication device. The host communication device comprises the elements that do not exist in the slim tag, up to the point where the slim tag is implemented entirely using the elements of its host communication device. Because the slim tag utilizes for its operation some of the components of the host communication device, the slim tag must be electrically coupled to the host communication device in a way that enables it to cooperate with the required components.

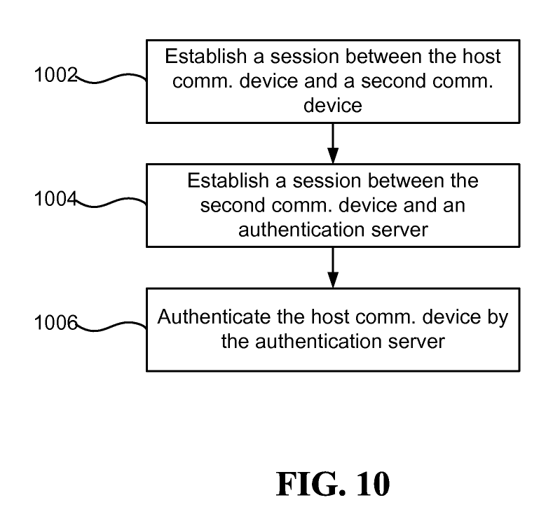

FIG. 10 is a flow diagram of the main steps in the authentication processes of the disclosed embodiments. The authentication processes comprise: In step 1002, establishing a communication session between the host communication device and a second communication device. In step 1004, establishing a communication session between the second communication device and an authentication server. And in step 1006, authenticating the host communication device by the authentication server utilizing a slim tag integrated with the host communication device.

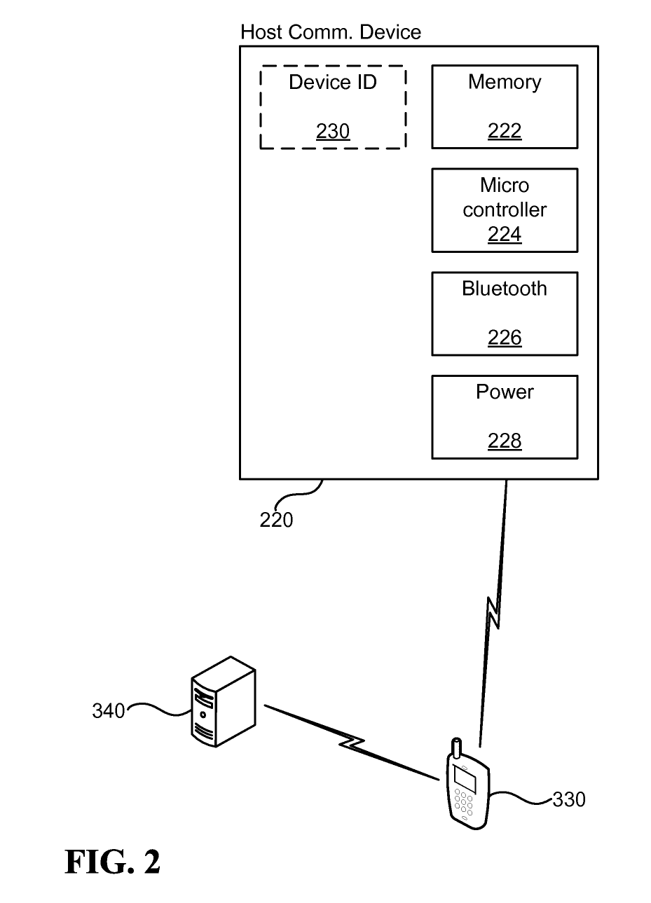

In one embodiment, the host communication device to be authenticated comprises a short range communication functionality, such as Bluetooth, and the authentication software uses the resources of the host communication device. Therefore, the authentication tag (if exists at all) does not have to include means for storing and running the authentication software. FIG. 2 illustrates one embodiment wherein the entire functionality of the authentication tag is implemented using the resources of the host communication device. Optionally, the authentication functionality may be operated while the host communication device 220 is in a low power mode and/or while the host communication device 220 is in a mode of operation other than its normal mode of operation. All host communication devices may comprise an optional device ID, illustrated in FIG. 2 by device ID 230. The device ID 230 may be utilized for many purposes, such as establishing or maintaining a communication session, or supporting an authentication process. In one embodiment, memory 222 is a programmable memory that may be programmed as needed.

In one embodiment, the host communication device 220, having the authentication functionality, communicates with a second communication device 330 using its short range communication element 226. The second communication device 330 communicates with an authentication server 340. Optionally, the second communication device 330 authenticates the host communication device 220. Alternatively, the authentication server 340 authenticates the host communication device 220. Optionally, the host communication device 220 is a cellular phone. Optionally, the second communication device 330 is also a cellular phone.

In one example, the host communication device is a cellular phone, the authentication software is installed by the manufacturer, and the authentication software may operate when the cellular phone does not have a network identity, such as a Subscriber Identity Module (SIM) in the case of GSM, because the software utilizes the short rage communication module.

For example, the authentication software may run as part of the boot phase of the cellular phone. In this case, the authentication software utilizes the short range communication module of the cellular phone to search for a second short range communication device in its surrounding area. Upon establishing a communication session with a second short range communication device having the proper authentication software, the second short range communication device is able to authenticate the cellular phone. The second short range communication device may authenticate the cellular phone using its own resources or by communicating with an authentication server, optionally over the Internet. The second short range communication device may be, for example, a second cellular phone, a PDA, or a computer connected to the Internet.

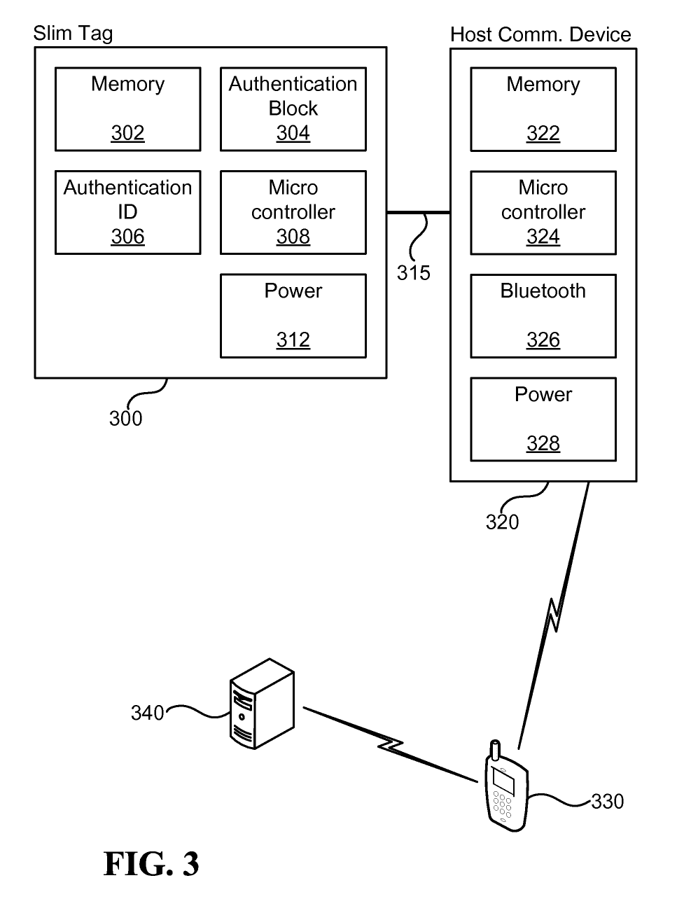

In one embodiment, the authentication tag is electronically coupled to a host communication device to be authenticated, wherein the host communication device to be authenticated comprises short range communication functionality, such as Bluetooth. Therefore, the authentication tag may use the resources of the host communication device and not include a short range communication element. FIG. 3 illustrates an authentication tag 300 comprising the following elements: a memory 302 for the authentication software, such as random access memory (RAM); an authentication block 304, such as a challenge-response authentication block or any other symmetric or asymmetric authentication logic; a memory 306 for storing the authentication identification number, such as EEPROM; a microcontroller 308; and a power supply 112. The authentication tag 300 is electronically coupled to the host communication device 320 through schematic coupler 315. The host communication device 320 comprises, among its other elements, (i) a memory 322, which may include one or more memories of different types, (ii) a microcontroller 324, which may include one or more microcontrollers and/or processing units, optionally having different characteristics, (iii) a short range communication element 326, such as Bluetooth or any other appropriate standard, and (iv) a power supply, such as a battery.

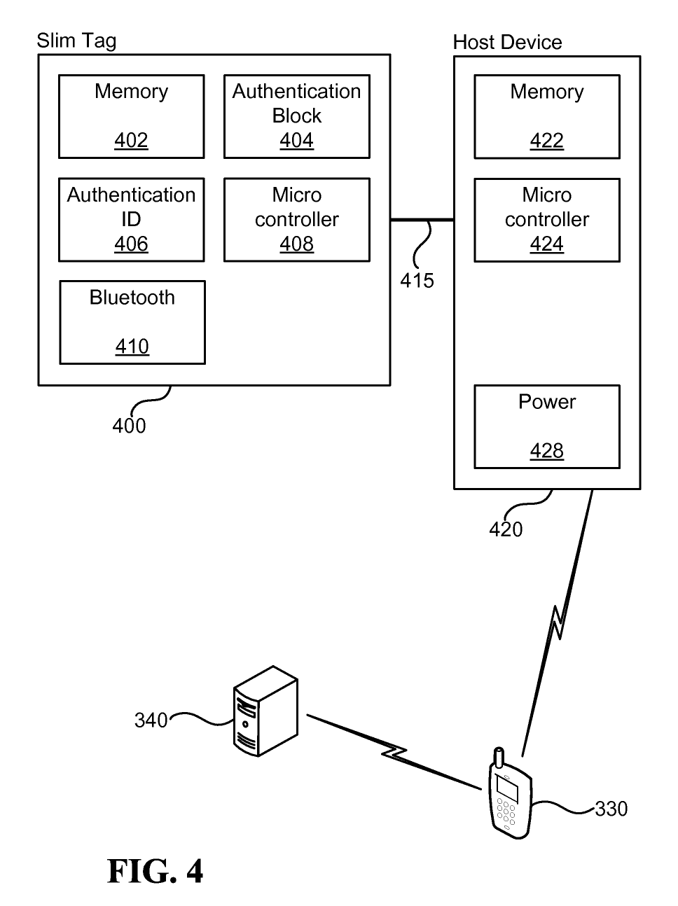

In one embodiment, the authentication tag is electronically coupled to a host device to be authenticated, wherein the host device to be authenticated comprises a power source. Therefore, the authentication tag may be powered by the host device and not include an internal power source, such as a battery. FIG. 4 illustrates an authentication tag 400 comprising the following elements: a memory 402 for the authentication software, such as random access memory (RAM); an authentication block 404, such as a challenge-response authentication block or any other symmetric or asymmetric authentication logic; a memory 406 for storing the authentication identification number, such as EEPROM; a microcontroller 408; and a short range communication element 410, such as Bluetooth.

Due to the fact that the authentication tag 400 includes a short range communication element 410, the host device 420 may be without a short range communication element.

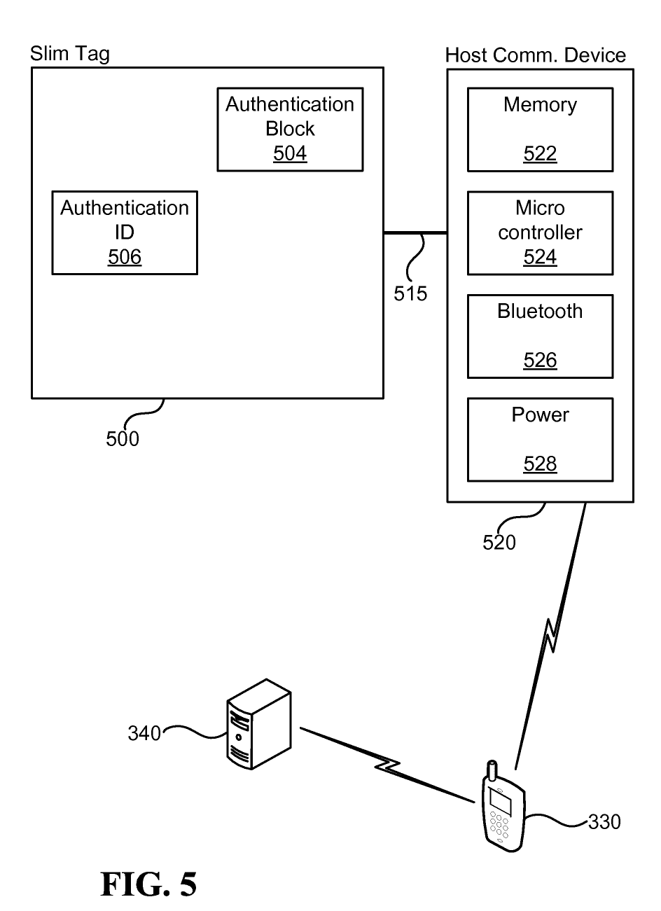

In one embodiment, the authentication tag comprises an authentication block and an authentication ID. FIG. 5 illustrates an authentication tag 500, comprising an authentication block 504 and an authentication ID 506, coupled to a host communication device 520. Optionally, the authentication tag 500 is added as an extra component to the host communication device 520 in order to increase the security level of the authentication mechanism. The authentication tag 500 receives its power from the power source 528 and cooperates with the required elements of the host communication device 520, such as the memory 522, the microcontroller 524, which may be almost any kind of processing unit, and the short range communication means 526.

Optionally, the authentication process, which utilizes the authentication block 504 and the authentication ID 506, comprises communication with a second short range communication element 330, using the short range communication means 526 of the host communication device 520. And optionally, the second short range communication element 330 authenticates the host communication device 520 by communicating with an authentication server 340.

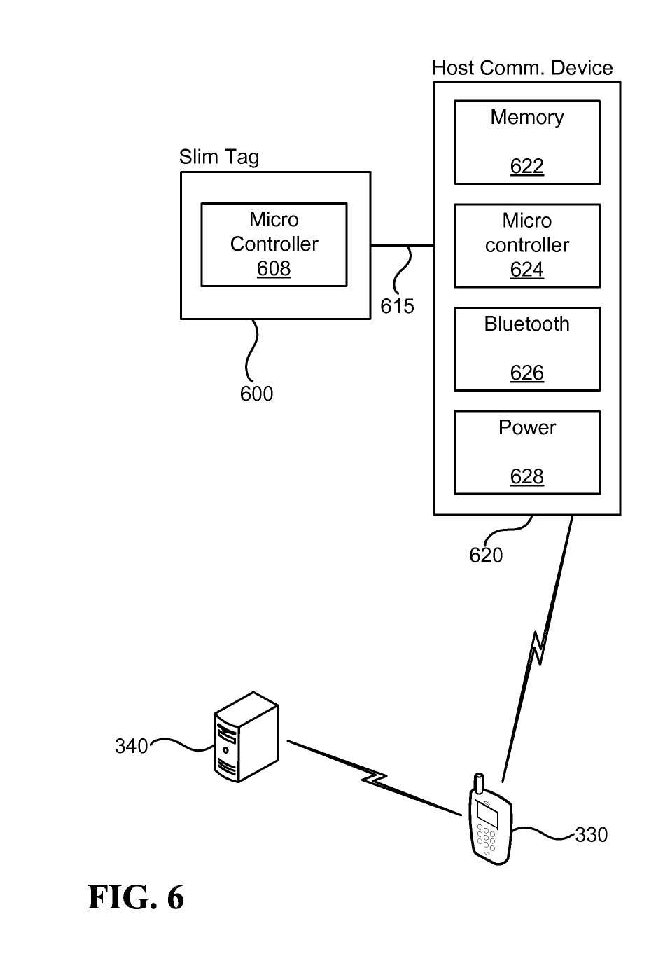

In one embodiment, the authentication tag comprises a microcontroller. FIG. 6 illustrates such an authentication tag 600 coupled to a host communication device 620. Optionally, the microcontroller 608 implements at least some of the authentication process, receives its power from the power source 628 of the host communication device 620, and communicates with the second short range communication element 330 using the short range communication means 626 of the host communication device 620. Optionally, the second short range communication element 330 authenticates the host communication host communication device 520 by communicating with an authentication server 340.

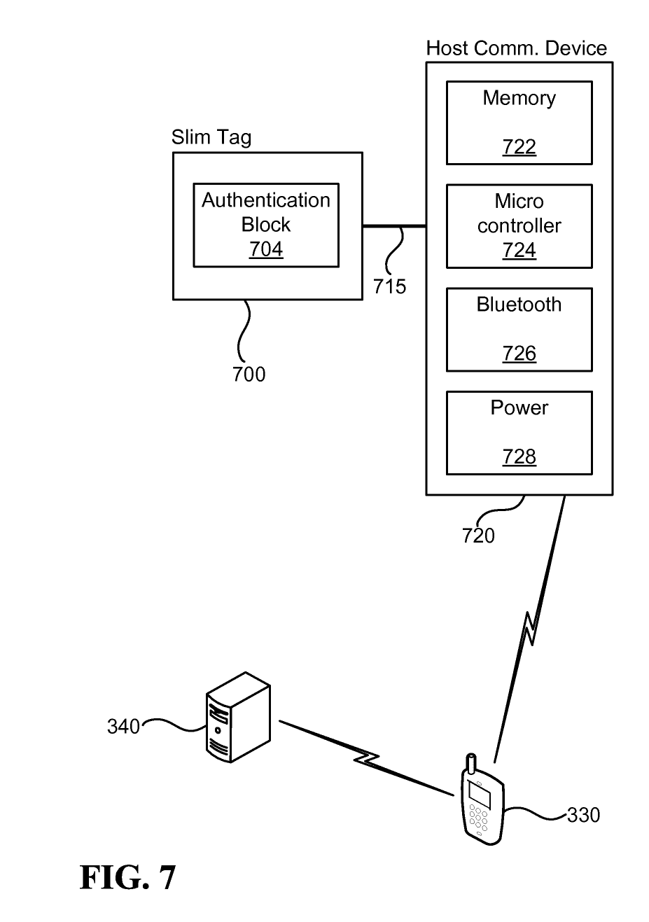

In one embodiment, the authentication tag comprises an authentication block. FIG. 7 illustrates such an authentication tag 700 coupled to a host communication device 720. Optionally, the authentication block 704 implements the authentication process, such as a challenge-response authentication or any other symmetric or asymmetric authentication process. The authentication block 704 may receive its power from the power source 728 of the host communication device 720, and communicate with the second short range communication element 330 using the short range communication means 726 of the host communication device 720.

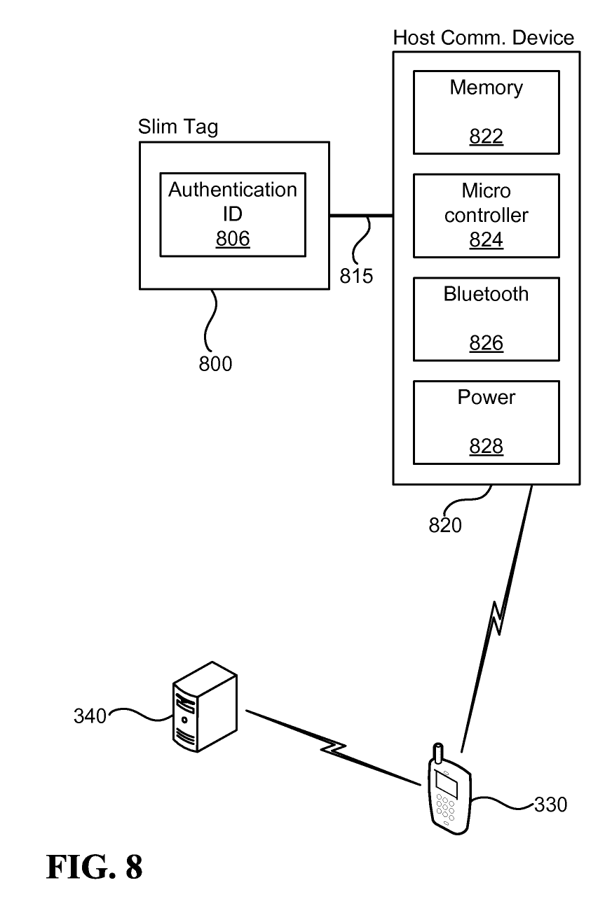

In one embodiment, the authentication tag comprises a one time programming (OTP) memory element. FIG. 8 illustrates such an authentication tag 800 coupled to a host communication device 820. Optionally, the OTP memory 806 stores data used by the authentication process. An example of such data is a list of identification numbers to be used when interrogating the host communication device.

In one embodiment, the data used by the authentication process is burned on the read only memory of the host communication device during the manufacturing process. An example of such data is a list of identification numbers to be used when interrogating the host communication device.

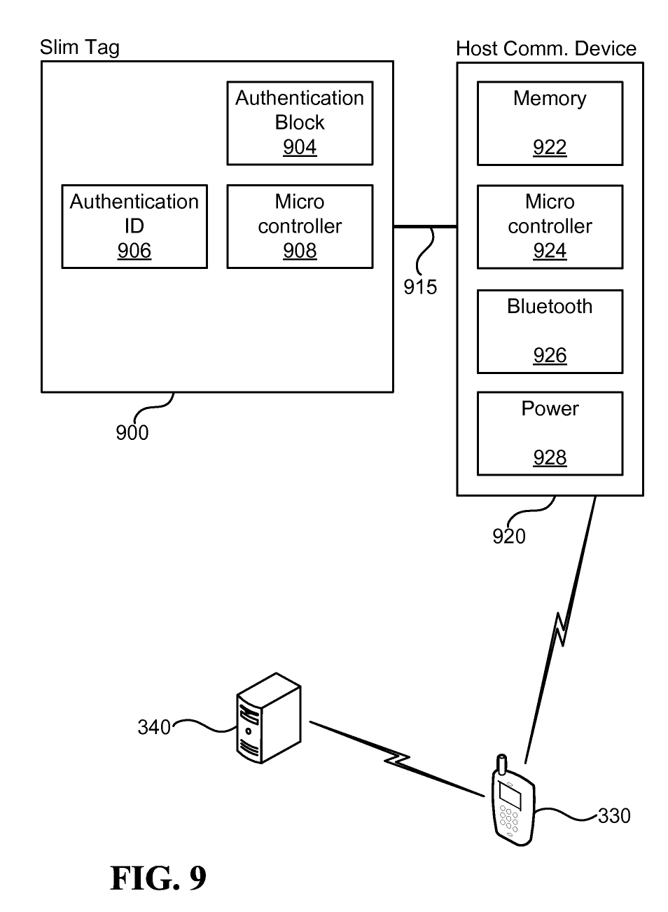

In one embodiment, the authentication tag comprises an authentication block, an authentication ID, and a microcontroller. FIG. 9 illustrates an authentication tag 900, comprising an authentication block 904, an authentication ID 906, and a microcontroller, coupled to a host communication device 920. Optionally, the authentication tag 900 is added as an extra component to the host communication device 920 in order to increase the security level of the authentication mechanism. The authentication tag 900 receives its power from the power source 928, and cooperates with the required elements of the host communication device 920, such as the memory 922, and the short range communication means 926.

Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination.

While the methods disclosed herein have been described and shown with reference to particular steps performed in a particular order, it will be understood that these steps may be combined, sub-divided, or reordered to form an equivalent method without departing from the teachings of the embodiments. Accordingly, unless specifically indicated herein, the order and grouping of the steps is not a limitation of the embodiments.

Any citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents. In the claims, means-plus-function clauses are intended to cover the structures described herein as performing the recited function and not only structural equivalents, but also equivalent structures.

What is claimed is:

1 A host communication device comprising: a memory, a microcontroller, a short range communication element, a power supply, and a slim tag for authenticating the host communication device by utilizing the short range communication; wherein the slim tag utilizes at least one of the components of the host communication device in order to establish a short range communication session with a second communication device.

2. The host communication device of claim 1, wherein the second communication device authenticates the host communication device by communicating with an authentication server.

3. The host communication device of claim 2, wherein the short range communication between the slim tag and the second communication device is a Bluetooth communication.

4. The host communication device of claim 3, wherein the host communication device is a cellular phone, and the host communication device can be authenticated without being connected to a cellular network.

5. The host communication device of claim 3, wherein the host communication device is a cellular phone, and the host communication device can be authenticated without including a SIM card.

6. The host communication device of claim 3, wherein the second communication device is a cellular phone.

7. The host communication device of claim 3, wherein the second communication device is a cellular phone, and the host communication device is a laptop or a personal digital assistant.

8. The host communication device of claim 3, wherein the slim tag utilizes the power source of the host communication device.

9. The host communication device of claim 3, wherein the slim tag utilizes the Bluetooth component of the host communication device.

10. The host communication device of claim 3, wherein the slim tag utilizes the microcontroller of the host communication device.

11. The host communication device of claim 3, wherein the slim tag utilizes one or more of the memories of the host communication device.

12. The host communication device of claim 3, wherein the slim tag consists essentially of an authentication block and an authentication ID.

13. The host communication device of claim 3, wherein the slim tag consists essentially of an authentication block an authentication ID and a microcontroller.

14. The host communication device of claim 3, wherein the slim tag consists essentially of a microcontroller.

15. A slim authentication tag to be integrated in a host communication device; the slim authentication tag comprises an authentication block and utilizes at least one of the components of its host communication device in order to establish a communication session with a second communication device; wherein the second communication device authenticates the host communication device by communicating with an authentication server.

16. The slim authentication tag of claim 15, wherein the communication between the host communication device and the second communication device is a Bluetooth communication.

17. The slim authentication tag of claim 16, wherein the host communication device is a cellular phone, and the host communication device can be authenticated without being connected to a cellular network.

18. The slim authentication tag of claim 16, wherein the host communication device is a cellular phone, and the host communication device can be authenticated without including a SIM card.

19. The slim authentication tag of claim 16, wherein the second communication device is a cellular phone.

20. The slim authentication tag of claim 16, wherein the host communication device and the second communication device are cellular phones.

21. The slim authentication tag of claim 16, wherein the second communication device is a cellular phone, and the host communication device is a laptop or a personal digital assistant.

22. The slim authentication tag of claim 16, wherein the slim authentication tag further comprises an authentication ID.

23. The slim authentication tag of claim 22, wherein the slim authentication tag further comprises a microcontroller and memory.

24. The slim authentication tag of claim 22, wherein the slim authentication tag further comprises an authentication block and a microcontroller.

25. The slim authentication tag of claim 22, wherein the slim authentication tag utilizes the power source and the Bluetooth components of the host communication device.

26. A slim authentication tag to be integrated in a host communication device; the slim authentication tag comprises a microcontroller and utilizes at least one of the components of its host communication device in order to establish a communication session with a second communication device; wherein the second communication device authenticates the host communication device by communicating with an authentication server.

27. The slim authentication tag of claim 26, wherein the communication between the host communication device and the second communication device is a Bluetooth communication.

28. The slim authentication tag of claim 27, wherein the host communication device is a cellular phone, and the host communication device can be authenticated without being connected to a cellular network.

29. The slim authentication tag of claim 27, wherein the host communication device and the second communication device are cellular phones.

30. The slim authentication tag of claim 27, wherein the second communication device is a cellular phone, and the host communication device is a laptop or a personal digital assistant.

31. The slim authentication tag of claim 27, wherein the slim authentication tag further comprises an authentication ID and an authentication block.

32. The slim authentication tag of claim 27, wherein the slim authentication tag further comprises a memory storing authentication software.

33. The slim authentication tag of claim 32, wherein the slim authentication tag further comprises an authentication ID and an authentication block.

34. The slim authentication tag of claim 32, wherein the slim authentication tag utilizes the power source and the Bluetooth components of the host communication device.

35. A system comprising: a first host communication device comprising: a memory, a microcontroller, a short range communication element, a power supply, and a device ID; the first host communication device loads an authentication program to the memory and communicates with a second communication device utilizing the short range communication element; the second communication device communicates with an authentication server for authenticating the first device.

36. The system of claim 35, wherein first host communication device is a cellular phone.

37. The system of claim 36, wherein the cellular phone does not have to have a network identity in order to communicate with the second communication device.

38. The system of claim 37, wherein he second communication device is a second cellular phone.

39. The system of claim 37, wherein the authentication server authenticates the cellular phone.
